(19) United States
(12) Patent Application Publication
(10) Pub. No.: US 2025/0104906 A1
(43) Pub. Date: Mar. 27, 2025

(54) MULTILAYER INDUCTOR AND MANUFACTURING METHOD THEREOF

(71) Applicant: Murata Manufacturing Co., Ltd., Kyoto-fu (JP)

(72) Inventor: Akinori HAMADA, Nagaokakyo-shi (JP)

(73) Assignee: Murata Manufacturing Co., Ltd., Kyoto-fu (JP)

(21) Appl. No.: 18/897,901

(22) Filed: Sep. 26, 2024

(30) Foreign Application Priority Data
Sep. 27, 2023 (JP) 2023-166266

(51) Int. Cl. H01F 27/29; H01F 27/02; H01F 27/245; H01F 27/28; H01F 41/00

(52) U.S. Cl. CPC H01F 27/292; H01F 27/022; H01F 27/245; H01F 27/2804; H01F 41/005; H01F 2027/2809

(57) ABSTRACT

A multilayer inductor includes a body. The body includes, within a magnetic member having a stack of magnetic layers containing iron powder, a coil including a coil conductor wound around and a through conductor that is electrically connected to the coil conductor and exposed in a bottom surface of the magnetic member. The multilayer inductor also includes an outer electrode that is on the through conductor and is electrically connected to the through conductor; and an exterior resin layer on the bottom surface of the magnetic member. The outer electrode includes protrusions that protrude perpendicular to a stacking direction of the magnetic layers in an upper end portion on a far side from the through conductor and a lower end portion on a near side from the through conductor in the stacking direction. The exterior resin layer extends across between the protrusions in the upper and lower end portions.

### CROSS-REFERENCE TO RELATED APPLICATION

This application claims benefit of priority to Japanese Patent Application No. 2023-166266, filed Sep. 27, 2023, the entire content of which is incorporated herein by reference.

### BACKGROUND

### Technical Field

The present disclosure relates to a multilayer inductor and a manufacturing method thereof.

### Background Art

With the recent improvement in equipment functionality, DC-DC converters within voltage conversion circuits are advancing to handle higher currents and implement higher efficiency, and power inductors used in these devices are experiencing an increase in rated currents.

Japanese Unexamined Patent Application Publication No. 2020-141079 illustrating an example of the aforementioned inductors discloses a passive component including: a base part; an inner conductor incorporated in the base part; an extended conductor that is electrically connected to the inner conductor and is extended toward the lower surface of the base part; and an outer electrode electrically connected to the extended conductor.

### SUMMARY

In the conventional passive component, as illustrated in FIG. 8, for example, an outer electrode 100 is just formed on the lower surface of a base portion 110 and is coupled to an extended conductor 105, which is extended toward the lower surface. The conventional passive component therefore has a problem with the coupling strength between the outer electrode and the extended conductor.

Accordingly, the present disclosure provides a multilayer inductor with enhanced coupling strength between an outer electrode and an extended conductor and provide a method of manufacturing the same.

The present disclosure is related to a multilayer inductor including a body. The body includes, within a magnetic member having a stack of magnetic layers containing iron powder, a coil including a coil conductor wound around; and a through conductor that is electrically connected to the coil conductor and is extended toward a bottom surface of the magnetic member. The multilayer inductor also includes an outer electrode that is arranged on the through conductor and is electrically connected to the through conductor; and an exterior resin layer arranged on the bottom surface of the magnetic member of the body. The outer electrode includes protrusions that protrude perpendicular to a stacking direction of the magnetic layers in an upper end portion on a far side from the through conductor and a lower end portion on a near side from the through conductor in the stacking direction. The exterior resin layer is arranged across between the protrusions in the upper end portion and the lower end portion.

According to the present disclosure, it is possible to provide a multilayer inductor with enhanced coupling strength between the outer electrode and the through conductor and provide a method of manufacturing the same. Specifically, in the multilayer inductor, the outer electrode includes protrusions in the upper end portion and the lower end portion and the exterior resin layer is arranged across between the protrusions in the upper end portion and the lower end portion. This can enhance the coupling strength between the outer electrode and the extended conductor.

### BRIEF DESCRIPTION OF THE DRAWINGS

FIG. 1 is a schematic perspective view of an example of a multilayer inductor of the first embodiment;

FIG. 2 is an exploded perspective view for explaining a multilayer structure of the multilayer inductor of the first embodiment;

FIG. 3 is a cross-sectional view of the multilayer inductor of the first embodiment, illustrating an enlarged cross-sectional view around an outer electrode;

FIG. 4 is a partial enlarged cross-sectional view of a Z part in FIG. 3;

FIG. 5 is a schematic perspective view of an example of a multilayer inductor of a second embodiment;

FIG. 6 is a schematic perspective view of an example of a multilayer inductor array of the present disclosure;

FIG. 7A is a flow diagram illustrating a manufacturing method of a multilayer inductor of the present disclosure;

FIG. 7B is a cross-sectional view illustrating details of an exterior resin layer formation step in the manufacturing method of a multilayer inductor of the present disclosure; and

FIG. 8 is a cross-sectional view of a multilayer inductor of the prior art, illustrating an enlarged cross-sectional view around an outer electrode.

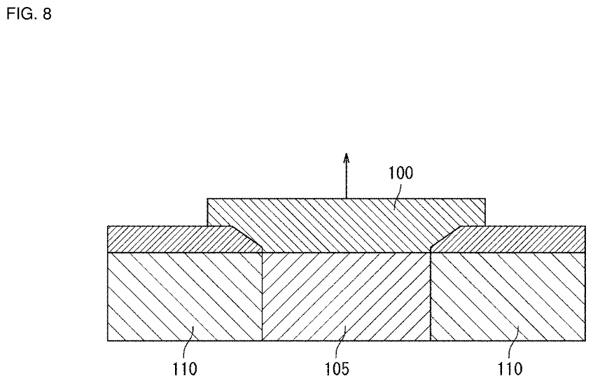

### DETAILED DESCRIPTION

Hereinafter, a multilayer inductor of the present disclosure will be described. The present disclosure is not limited to the following configurations and may be properly changed without departing from the scope of the present disclosure. The present disclosure also includes combinations of preferable configurations described below.

The multilayer inductor of the present disclosure is used as a choke coil of DC-DC converters, for example. The multilayer inductor of the present disclosure is also applicable for purposes other than DC-DC converters.

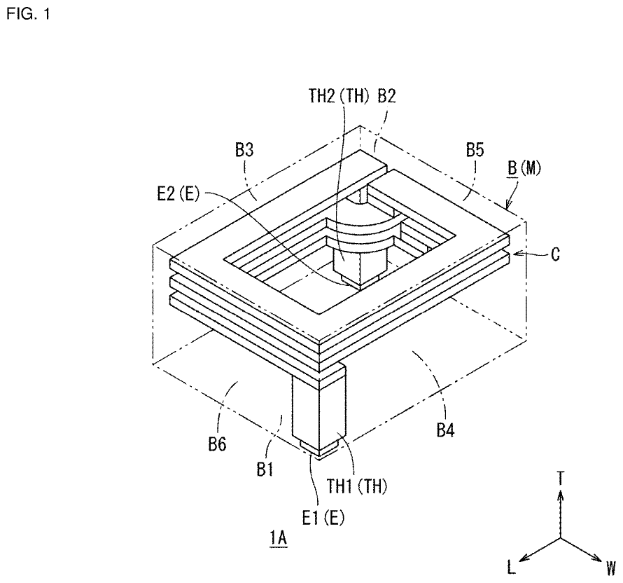

In this specification, terms (“parallel”, “orthogonal”, “perpendicular”, or the like, for example) representing the relationship between elements and terms representing the shape of elements do not only imply the exact literal meaning but also imply a range that is substantially equivalent thereto, for example, a range including differences of about several percents. In this specification, the direction in which magnetic layers and coil conductors that constitute a body are stacked is referred to as a stacking direction (a direction T in FIG. 1, for example).

The term “plan view” in this specification refers to a state (a top or bottom view) of an object as viewed from above or below along a thickness direction based on the stacking direction. The term “cross-sectional view” refers to a state (a cross-sectional view) of a cross section of an object as viewed in a direction (a direction L or W in FIG. 1, for example) substantially perpendicular to the stacking direction T. The terms “vertical direction” and “horizontal direction” directly or indirectly used in this specification correspond to the vertical direction and the horizontal direction in the drawings, respectively. Identical symbols or signs denote the same member or portion or the same meaning or content unless otherwise specified. In a preferred aspect, the vertically downward direction (that is, the direction of gravity) can be understood to correspond to a “downward direction” while the direction opposite thereto can be understood to correspond to an “upward direction”.

The drawings below are schematic, and the dimensions, aspect ratio scales, and the like are different from those of actual products in some cases.

### First Embodiment of Multilayer Inductor

First, the first embodiment of the multilayer inductor of the present disclosure will be described with reference to FIGS. 1 to 6 and FIGS. 7A and 7B. The shape, arrangement, and the like of the multilayer inductor and each constituent element thereof are not limited to examples illustrated in the drawings.

FIG. 1 is a see-through perspective view of a multilayer inductor 1A of the present disclosure. As illustrated in FIG. 1, the multilayer inductor 1A includes a body B, an exterior resin, and outer electrodes E. The body B includes a coil C and through conductors TH within a magnetic member M. The coil C includes coil conductors wound around. The through conductors TH are electrically connected to the coil conductors and are extended toward the bottom surface of the magnetic member. The magnetic member M includes a stack of magnetic layers containing iron powder. The exterior resin is arranged on the bottom surface of the magnetic member and includes openings. The outer electrodes E are arranged in the openings of the exterior resin layer and are electrically connected to the through conductors. The coil C has 2.5 coil turns. Each constituent element will be described in detail below.

### Body

The body B has, for example, a cuboid shape or a substantially cuboid shape with six faces. The vertices and edges of the body B may be rounded. Each vertex refers to an intersection of three faces of the body B, and each edge refers to an intersection of two faces of the body B.

In FIG. 1, the length direction, the width direction, and the height direction in the multilayer inductor 1A and the body B are indicated by an L direction, a W direction, and a T direction, respectively. The length direction L, the width direction W, and the height direction T are perpendicular to each other. The mounting surface of the multilayer inductor 1A is, for example, a plane (an L-W plane) that is parallel to the length direction L and the width direction W.

The body B illustrated in FIG. 1 includes: a first major surface B1 and a second major surface B2, which face each other in the height direction T; a first end surface B3 and a second end surface B4, which are perpendicular to the height direction T and face each other in the length direction L; and a first side surface B5 and a second side surface B6, which face each other in the width direction W, that is perpendicular to the length direction L and the height direction T. In the example illustrated in FIG. 1, the first major surface B1 of the body B corresponds to the mounting surface (the bottom surface) of the body B. The second major surface B2 may serve as the mounting surface of the body B.

The body B includes: the magnetic member M having a stack of magnetic layers ML; the coil C having coil conductors CM wound around; and the through conductors TH, which are electrically connected to the coil conductors and are extended toward the bottom surface of the body B. Specifically, the body B may include a plurality of the magnetic layers ML and a plurality of the coil conductors CM in a stacking direction (the height direction T, for example).

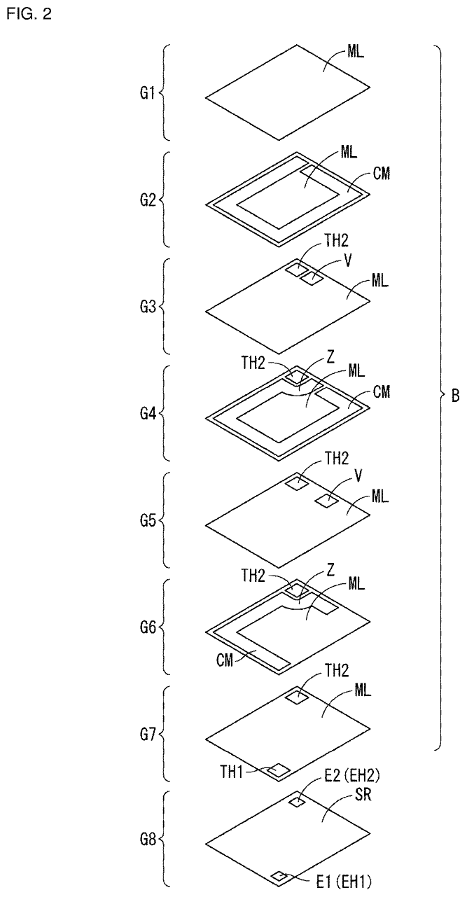

FIG. 2 is an exploded perspective view for explaining the multilayer structure of the multilayer inductor 1A of the present disclosure. In the first embodiment, the multilayer inductor 1A is composed of a stack of layer groups G1 to G7 including the magnetic layers ML, the coil conductors CM, and the through conductors TH as illustrated in FIG. 2. The boundaries between layers of the multilayer structure included in the body B may disappear. Each layer group may include a plurality of layers having an identical pattern.

The multilayer inductor 1A may be structured by: stacking the layer groups G1 to G7 on top of each other and firing the same stack to create the body B; further stacking a layer group G8 including an exterior resin layer SR having openings EH (EH1 and EH2, for example) for the outer electrodes E (E1 and E2, for example); and forming the outer electrodes E (E1 and E2, for example) using a later-described method.

The layer group G1 includes one of the magnetic layers ML and constitutes the second major surface B2 of the body B.

The layer group G2 includes another one of the magnetic layers ML and one of the coil conductors CM. The coil conductor CM of the layer group G2 constitutes about one turn of the coil C. To be more specific, the coil conductor CM is substantially arranged along the outer peripheral edge of the magnetic layer ML.

The layer group G3 includes still another one of the magnetic layers ML, a part of a second through conductor TH2 that electrically couples the coil conductor CM of the layer group G2 and the second outer electrode E2, and a via conductor V for coupling the coil conductors CM adjacent in the stacking direction. The part of the second through conductor TH2 is arranged near a corner of the magnetic layer ML. The via conductor V is arranged adjacent to the part of the second through conductor TH2. The term “via conductor” (via hole conductor) is used as an idea of a path for electrical coupling of the coil C (CM) while the term “through conductor” (through-hole conductor) is used as an idea of a path for electrical coupling of the coil C (CM) to each outer electrode E.

The layer group G4 includes still another one of the magnetic layers ML, a part of the second through conductor TH2 that electrically couples the part of the second through conductor TH2 of the layer group G3 and the second outer electrode E2, and still another one of the coil conductors CM. The coil conductor CM of the layer group G4 constitutes about one turn of the coil C. To be more specific, the coil conductor CM constitutes a winding structure as follows: the coil conductor CM is arranged along the outer peripheral edge of the magnetic layer ML while avoiding the second through conductor TH2 with an avoidance section Z; and the end portions of the coil conductor CM are spaced from each other. To be more specific about the avoidance section Z, the avoidance section Z provided for the layer group G4 may be arranged to the inside of the coil conductor CM arranged along the outer peripheral edge of the layer group G2 to avoid the second through conductor TH2.

The layer group G5 includes still another one of the magnetic layers ML, a part of the second through conductor TH2 that electrically couples the part of the second through conductor TH2 of the layer group G4 and the second outer electrode E2, and another via conductor V for coupling the coil conductors CM adjacent in the stacking direction. The via conductor Vis arranged adjacent to the second through conductor TH2 in such a position as to be able to be electrically connected to an end portion of the coil conductor CM of the layer group G4.

The layer group G6 includes still another one of the magnetic layers ML, a part of the second through conductor TH2 that electrically couples the part of the second through conductor TH2 of the layer group G5 and the second outer electrode E2, and still another one of the coil conductors CM. The coil conductor CM of the layer group G6 constitutes about 0.5 turns of the coil C. To be more specific, the coil conductor CM constitutes a winding structure as follows: the coil conductor CM is arranged along the outer peripheral edge of the magnetic layer ML while avoiding the second through conductor TH2 with another avoidance section Z; and the end portions of the coil conductor CM are spaced from each other. To be more specific about the avoidance section Z, the avoidance section Z provided for the layer group G6 may be arranged to the inside of the coil conductor CM arranged along the outer peripheral edge of the layer group G2 to avoid the second through conductor TH2.

The layer group G7 includes still another one of the magnetic layers ML, a part of the second through conductor TH2 that electrically couples the part of the second through conductor TH2 of the layer group G6 and the second outer electrode E2, and a first through conductor TH1, which electrically couples the coil conductor CM of the layer group G6 and the first outer electrode E1. The first through conductor TH1 is arranged near a corner of the magnetic layer ML.

Furthermore, the layer group G8 is provided on the fired body B. The layer group G8 includes the exterior resin layer SR and the outer electrodes E. The exterior resin layer SR includes: a first opening EH1 for the first outer electrode E1, which is electrically connected to the first through conductor TH1 of the layer group G7; and a second opening EH2 for the second outer electrode E2, which is electrically connected to the part of the second through conductor TH2 of the layer group G7. The outer electrodes E are arranged within the first opening EH1 and the second opening EH2. The first opening EH1 and the second opening EH2 are arranged near respective corners of the exterior resin layer SR.

When the body B has a multilayer structure including the layer groups G1 to G7 as described above, the multilayer inductor 1A can be designed with a higher degree of flexibility. For example, the multilayer inductor 1A including the first outer electrode E1 and the second outer electrode E2 in the bottom surface (the first major surface B1) of the body B is manufactured, and therefore, it is easy to extend the coil C to the bottom surface. The multilayer structure including the aforementioned layer groups G1 to G7 may be formed by sequentially performing printing (screen printing, for example) from the second major surface B2 side of the body B or from the first major surface B1 side to stack plural layers of the material constituting the magnetic layers ML, the material constituting the coil conductors CM, and the material constituting the through conductors and via conductors. In this case, the printing process may be repeated until the magnetic layer ML, coil conductor CM, through conductors, and via conductor of each of the layer groups G1 to G7 have a desired thickness.

As for the layer group G8, the exterior resin layer SR including the first opening EH1 and the second opening EH2 is formed on the first major surface B1 side after the body B is created. The exterior resin layer SR may be formed by photolithography, which performs printing (screen printing, for example) with a photosensitive resin material, followed by exposure and development. In the first opening EH1 and the second opening EH2, the outer electrodes E1 and E2 are formed by Cu plating or the like.

### Magnetic Member

The magnetic member M (see FIGS. 1 and 2), which is composed of a stack of the magnetic layers ML, contains iron powder particles MP composed of a magnetic material. The term “iron powder particles” in this specification is not limited to being exactly in powder form and includes powder-form matters bound by a heat treatment (firing) described later. The iron powder particles MP may contain Fe and/or Si. To be more specific, the iron powder particles MP may be Fe particles or Fe alloy particles. The Fe alloy may be of Fe—Si alloys, Fe—Si—Cr alloys, Fe—Si—Al alloys, Fe—Si—B—P—Cu—C alloys, and/or Fe—Si—B—Nb—Cu alloys or other alloys. The iron powder particles MP may contain impurities that were unintended in the manufacturing process, such as Cr, Mn, Cu, Ni, P, S, and/or Co. Furthermore, the iron powder particle MP may be contained in a magnetic paste, which will be described in detail in the description of the manufacturing method. The iron powder particles may contain an element (Cr, Al, Li, Zn, for example) that is more easily oxidized than Fe added in the process of preparing the magnetic paste.

The surface of the aforementioned iron powder particles MP may be covered with an insulating coating (not illustrated). Covering the surface of the iron powder particles MP with an insulating coating can enhance the insulation among the iron powder particles MP. The method of forming the insulating coating on the surface of the iron powder particles MP can be a sol-gel process, a mechanochemical process, or the like. The insulating coating may be composed of an oxide of P and/or Si or the like. The insulating coating may be an oxide film formed by oxidizing the surface of the iron powder particles MP. The thickness of the insulating coating is preferably greater than or equal to 1 nm and less than or equal to 50 nm (i.e., from 1 nm to 50 nm), more preferably greater than or equal to 1 nm and less than or equal to 30 nm (i.e., from 1 nm to 30 nm), and still more preferably greater than or equal to 1 nm and less than or equal to 20 nm (i.e., from 1 nm to 20 nm). For example, the thickness of the insulating coating covering the surface of the iron powder particles MP can be measured from a scanning electron microscope (SEM) photograph resulting from SEM imaging of a cross-section of an inductor sample, which was prepared by grinding the central part thereof.

The average particle size of the iron powder particles MP in the magnetic member M is preferably greater than or equal to 1 μm and less than or equal to 30 μm (i.e., from 1 μm to 30 μm), more preferably greater than or equal to 1 μm and less than or equal to 20 μm (i.e., from 1 μm to 20 μm), and still more preferably greater than or equal to 1 μm and less than or equal to 10 μm (i.e., from 1 μm to 10 μm). The average particle size of the iron powder particles MP within the magnetic member M can be measured by the procedure described below. A multilayer inductor sample is cut to prepare a sample cross-section. Specifically, the multilayer inductor sample is cut to prepare a cross-section (for example, a sample cross-section that passes through the center of the first through conductor of the body and is orthogonal to the mounting surface B1 of the body). For the prepared cross-section, images of regions (130 μm×100 μm, for example) at plural positions (five positions, for example) are taken with a SEM, and the obtained SEM images are subjected to an image analysis using image analysis software (image analysis software WinROOF2021 (made by MITANI CORPORATION), for example) to calculate equivalent circle diameters of the iron powder particles MP. The average of the calculated equivalent circle diameters is referred to as an average particle size of the metal magnetic particles. When the through conductor is polygonal, the multilayer inductor sample is cut perpendicular to one side of the through conductor, and when the through conductor is circular or elliptical, the multilayer inductor sample is cut perpendicular to the major axis.

Even when the iron powder particles MP contained in the magnetic layers ML is fired to be bound, there are voids within the iron powder particles MP, and the existence of voids reduces the body strength. The term “voids” in this specification intends spaces existing between adjacent granular substances. In other words, the term “voids” in this specification intends spaces defined by the positional relationship between adjacent granular substances. Voids can be observed in a SEM image of the sample cross-section that was obtained by cutting the sample of the multilayer inductor 1A as described above. In a concrete method to identify voids, the SEM image of the sample cross-section is obtained with the field of view set to 130 μm×100 μm. As a result of the image analysis for the obtained SEM image in terms of voids and other than voids with the image analysis software, in the magnetic member M, the proportion of the void area to the entire field of view may be greater than or equal to 10% and less than or equal to 40% (i.e., from 10% to 40%).

In the multilayer inductor 1A of the first embodiment, in order to minimize the reduction in body strength due to the existence of voids in the magnetic member, the fired body B may be impregnated with a resin material so that resin is arranged in voids. The arrangement of resin in voids within the magnetic member M can further enhance the body strength.

The resin provided in voids may contain epoxy resin, silicone resin, or phenol resin. When the resin infiltrating voids within the magnetic member M is epoxy resin or phenol resin, the strength of the body B can be further enhanced.

In the first embodiment, the surface roughness of the magnetic member bottom surface B1 (the first major surface B1) of the body B is higher than the surface roughness of the surface B2 (the second major surface B2) of the body B, which is opposite to the magnetic member bottom surface B1. Such surface roughness of the magnetic member bottom surface B1 of the body B is attributable to a grinding step described later. This can enhance the adhesion between the magnetic member bottom surface B1 of the body B and the exterior resin layer SR.

The surface roughness of the magnetic member bottom surface B1 of the body B is not limited and may be, for example, greater than or equal to 0.3 μm and less than or equal to 1.0 μm (i.e., from 0.3 μm to 1.0 μm) and particularly greater than or equal to 0.5 μm and less than or equal to 1.0 μm (i.e., from 0.5 μm to 1.0 μm). The surface roughness of the surface B2 of the body B, which is opposite to the magnetic member bottom surface B1, is not limited and may be, for example, greater than or equal to 0.1 μm and less than or equal to 0.6 μm (i.e., from 0.1 μm to 0.6 μm). The difference in surface roughness between the magnetic member bottom surface B1 of the body B and the surface B2 of the body B, which is opposite to the magnetic member bottom surface B1, may be typically greater than or equal to 0.1 μm and less than or equal to 0.9 μm (i.e., from 0.1 μm to 0.9 μm).

In this specification, the surface roughness of the body B (particularly the magnetic member M) is a surface roughness based on so-called arithmetic average roughness Ra and is determined as the average of measurements taken at 20 specific points in central part of the bottom surface of the body B.

### Coil

The coil includes the plurality of coil conductors CM arranged in the stacking direction (the height direction T, for example). The coil of the first embodiment may have, for example, about 2.5 turns by the layer groups G2, G4, and G6 as illustrated in FIG. 2.

The coil conductor CM in each layer group has the same thickness. The coil conductors CM may be composed of a metal conductor, for example, such as Ag, Cu, and/or Pd or the like. The coil conductors CM may be formed by, for example, printing with a conductive paste on the aforementioned magnetic layers ML.

### Through Conductor and Via Conductor

The coil C may include the through conductors TH and the via conductors V. The through conductors TH may include the first through conductor TH1 and the second through conductor TH2. The first through conductor TH1 and the second through conductor TH2 may be provided within the body B.

The first through conductor TH1 may couple the first outer electrode E1 and the end portion of the coil C that is associated with the coil conductor CM situated closest to the bottom surface (the first major surface B1) of the body B. The first through conductor TH1 may extend in the stacking direction (the height direction T, for example). The first through conductor TH1 may have a multilayer structure.

The second through conductor TH2 may couple the other end portion of the coil C and the second outer electrode E2. The second through conductor TH2 may extend in the stacking direction (for example, the height direction T). The second through conductor TH2 may have a multilayer structure.

In such a manner, the through conductors TH are arranged within the body B (particularly the magnetic member M) and electrically couple the coil C and the outer electrodes E.

The via conductors V may electrically couple the coil conductors CM provided in layer groups adjacent to each other in the stacking direction. The length of the via conductors V in the stacking direction may be shorter than the length of the first through conductor TH1, the length of the second through conductor TH2, or the length of the via-holes. The via conductors V may have a multilayer structure.

The through conductors TH and via conductors V may be composed of a metal conductor (preferably, Ag), for example, such as Ag, Cu, and/or Pd or the like. The material of the through conductors and via conductors may be the same as or different from the material of the coil conductors CM. The through conductors and via conductors may be formed by, for example, forming penetrating-holes in the aforementioned magnetic layers ML and printing with a conductive paste within the through conductors. The through conductors and via conductors may typically be sintered bodies.

The surface roughness of the magnetic member bottom surface B1 of the body B is greater than the surface roughness of a through conductor end surface th1. Such surface roughness of the through conductor end surface th1 is attributable to a second etching step described later. This can further enhance the coupling strength between the outer electrode and the extended conductor.

The surface roughness of the through conductor end surface th1 is not limited and may be, for example, greater than or equal to 0.1 μm and less than or equal to 0.2 μm (i.e., from 0.1 μm to 0.2 μm). The surface roughness of the region of the magnetic member bottom surface B1 of the body B where the exterior resin layer is formed may be equal to the aforementioned surface roughness of the magnetic member bottom surface B1 of the body B. The difference in surface roughness between the through conductor end surface th1 and the magnetic member bottom surface B1 of the body B may be typically greater than or equal to 0.3 μm and less than or equal to 0.9 μm (i.e., from 0.3 μm to 0.9 μm).

In this specification, the surface roughness of the through conductor end surface th1 is a surface roughness based on so-called arithmetic average roughness Ra and is determined as the average of measurements taken at 20 specific points by a laser microscope (VK-X1000 made by KEYENCE CORPORATION).

### Outer Electrode

The outer electrodes E may include the first outer electrode E1 and the second outer electrode E2 as illustrated in FIG. 1. The first outer electrode E1 and the second outer electrode E2 may be provided in the first major surface B1 (the bottom surface) of the body B and may be electrically connected to the coil C. By providing the outer electrodes in the first major surface B1 of the body B, the multilayer inductor 1A can be properly mounted on a mounting substrate or the like.

The first outer electrode E1 may operate as an input electrode and/or an output electrode for the coil C. The first outer electrode E1 is square in plan view in FIGS. 1 and 2 but is not limited. The first outer electrode E1 may be rectangular or circular, for example.

The second outer electrode E2 may operate as an input electrode and/or an output electrode for the coil C. The second outer electrode E2 is square in plan view in FIGS. 1 and 2 but is not limited. The second outer electrode E2 may be rectangular or circular, for example.

The outer electrodes E (E1 and E2) are typically arranged on the through conductors TH (particularly their end surfaces) and are electrically connected to the respective through conductors TH.

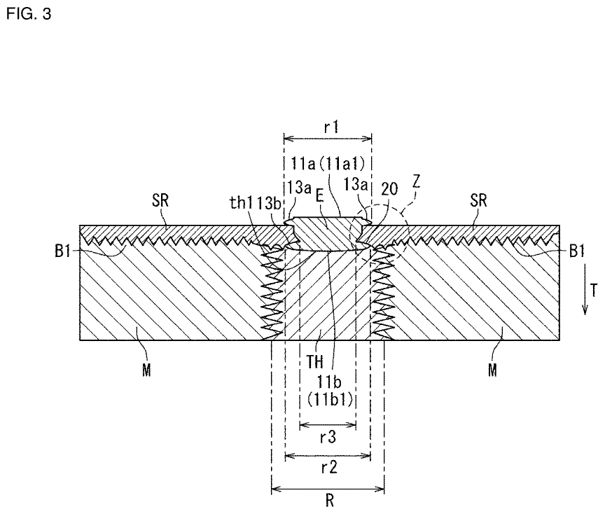

FIG. 3 is an enlarged cross-sectional view around an outer electrode in the multilayer inductor of the first embodiment and is an enlarged cross-sectional view around the outer electrode where the multilayer inductor of FIG. 1 is illustrated upside down. As illustrated in FIG. 3, in a cross-sectional view, the outer electrode E includes an upper end portion 11a and a lower end portion 11b in the stacking direction T and includes protrusions 13a and 13b in the upper and lower end portions 11a and 11b which protrude perpendicular to a stacking direction T, respectively. The protrusions 13a and 13b protrude in a flange shape in a direction perpendicular to the stacking direction T. The upper end portion 11a is an end portion that is on the far side from the through conductor TH in the stacking direction T. The lower end portion 11b is an end portion that is on the near side from the through conductor TH in the stacking direction T. To be specific, the upper end portion 11a and the lower end portion 11b of the outer electrode E refer to an end portion in an upper side and an end portion in a lower side, respectively, when the body B is placed with the magnetic member bottom surface B1 of the body B on the upper side and the surface B2, which is opposite to the magnetic member bottom surface B1 of the body B, on the lower side.

In a cross-sectional view, the widths (r1 and r2) of the upper end portion 11a and the lower end portion 11b of the outer electrode E are typically greater than an opening width r3 of the exterior resin layer SR (see FIG. 3). By setting the width r2 of the lower end portion 11b in the outer electrode E greater than the opening width r3 of the exterior resin layer SR, the protrusion 13b in the lower end portion 11b can effectively exert the anchoring effect. The opening width r3 of the exterior resin layer SR refers to the minimum width in a direction perpendicular to the stacking direction T in a cross-sectional view as if the outer electrode E were transparent.

Values of the widths (r1 and r2) of the upper end portion 11a and the lower end portion 11b of the outer electrode E are not limited and may, for example, independently be, for example, greater than or equal to 150 μm and less than or equal to 400 μm (i.e., from 150 μm to 400 μm).

The value of the opening width r3 of the exterior resin layer SR is not limited and may be, for example, greater than or equal to 1 μm and less than or equal to 10 μm (i.e., from 1 μm to 10 μm) and particularly greater than or equal to 5 μm and less than or equal to 10 μm (i.e., from 5 μm to 10 μm). The opening width r3 of the exterior resin layer SR is the minimum opening width in a cross-sectional view. The opening width r3 of the exterior resin layer SR corresponds to the minimum width of the outer electrode E as described above.

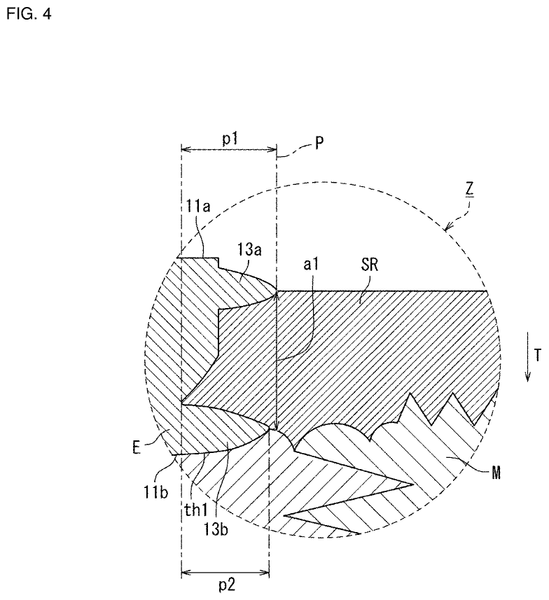

The protrusions (13a and 13b) in the upper end portion 11a and the lower end portion 11b have, for example, a protrusion length sufficient to be confirmed in a 5000× magnification cross-sectional view. FIG. 4 is a partial enlarged cross-sectional view of Z part in FIG. 3. As illustrated in FIG. 4, for example, the protrusions (13a and 13b) (p1 and p2 in FIG. 4) in the upper end portion 11a and the lower end portion 11b independently protrude by protrusion lengths of greater than or equal to 1 μm and less than or equal to 10 μm (i.e., from 1 μm to 10 μm) and particularly greater than or equal to 5 μm and less than or equal to 10 μm (i.e., from 5 μm to 10 μm) in a cross-sectional view. In terms of further enhancing the coupling strength between the outer electrode and the extended conductor, the protrusions (13a and 13b) in the upper end portion 11a and the lower end portion 11b protrude by protrusion lengths of preferably greater than or equal to 2 μm and less than or equal to 10 μm (i.e., from 2 μm to 10 μm) and more preferably greater than or equal to 4 μm and less than or equal to 10 μm (i.e., from 4 μm to 10 μm). The protrusions do not need to exactly protrude in a direction perpendicular to the stacking direction and may protrude in a direction transverse to the stacking direction as long as the protrusions protrude in the perpendicular direction as a whole.

The protrusion lengths of the protrusions 13a and 13b are based on the minimum width of the outer electrode E. To be specific, as illustrated in FIG. 4, the protrusion lengths of the protrusions 13a and 13b are protrusion lengths p1 and p2 in a direction perpendicular to the stacking direction T based on the minimum width of the outer electrode E, for example. The minimum width of the outer electrode E is the dimension corresponding to the opening width r3 of the exterior resin layer SR described later.

The thickness of the exterior resin layer SR is not limited and may be, for example, greater than or equal to 0.5 μm and less than or equal to 20 μm (i.e., from 0.5 μm to 20 μm) and particularly greater than or equal to 4 μm and less than or equal to 10 μm (i.e., from 4 μm to 10 μm). The thickness of the exterior resin layer SR is determined as an average of measurements taken at 20 specific points.

The exterior resin constituting the exterior resin layer SR is not limited as long as it is resistant to etching in the second etching step described later. Examples thereof may be epoxy resin, acrylic resin, and the like.

The widths (r1 and r2) of the upper end portion 11a and the lower end portion 11b in the outer electrode E are typically smaller than the width R of the through conductor TH in a cross-sectional view (see FIG. 3). This can reduce an increase in direct-current resistance and miniaturize the surface area of the outer electrode E as seen from the mounting surface B1 side of the body B. The present disclosure is thereby particularly effective to a multilayer inductor for multiphase DC-DC converters. The term “multiphase” implies that plural coils are integrated in a single body like second and third embodiments described later. In the through conductor TH, particularly when it has a multilayer body, the side surface has unevenness as illustrated in FIG. 3. The width R of the through conductor TH is an average of the minimum width and the maximum width in a direction perpendicular to the stacking direction T in a cross-sectional view.

The width R of the through conductor TH is not limited and may be greater than or equal to 250 μm and less than or equal to 400 μm (i.e., from 250 μm to 400 μm).

The difference between the width R of the through conductor TH and the width r1 of the upper end portion 11a and the difference between the width R of the through conductor TH and the width r2 of the lower end portion 11b are not limited and may be, for example, independently, greater than or equal to 0 μm and less than or equal to 50 μm (i.e., from 0 μm to 50 μm).

In the first embodiment, the outer electrode E is partially embedded in the exterior resin layer SR, between the protrusions in the upper end portion 11a and the lower end portion 11b. The phrase “to be embedded” means “to be contained and fixed”. In the first embodiment, to be more specific, the entirety of the outer electrode E is not embedded in the exterior resin layer, and only the part between the protrusion 13a in the upper end portion 11a and the protrusion 13b in the lower end portion 11b is contained within the exterior resin layer SR. Furthermore, an upper surface 11a1 of the upper end portion 11a and a lower surface 11b1 of the lower end portion 11b are not directly in contact with the exterior resin layer SR. The exterior resin layer SR is arranged (or fills) between the protrusions (13a and 13b) of the upper end portion 11a and the lower end portion 11b of the outer electrode E in the stacking direction T.

As described above, the outer electrode E includes the protrusions 13a and 13b in the upper end portion 11a and the lower end portion 11b and is partially embedded in the exterior resin layer SR, between the protrusions 13a and 13b. This enhances the coupling strength of the outer electrode E with the body B (particularly the through conductor TH). In the outer electrode E, for example, the upper end portion 11a is visible in plan view in the stacking direction T while the lower end portion 11b is not visible. In plan view of the outer electrode E in the stacking direction T, the upper end portion 11a as an “island” exists in the exterior resin layer SR as a “sea”.

From another perspective of the first embodiment, in a cross-sectional view, the outer electrode E sandwiches the exterior resin layer SR, between the protrusion 13a in the upper end portion 11a and the protrusion 13b in the lower end portion 11b. The protrusion 13b in the lower end portion 11b particularly, not only exerts the anchoring effect but also sandwiches the exterior resin layer SR together with the protrusion 13a in the upper end portion 11a. This enhances the coupling strength of the outer electrode E with the body B (particularly the through conductor TH) more sufficiently.

In terms of further enhancing the coupling strength between the outer electrode and the extended conductor, the thickness of the exterior resin layer SR between the protrusions is preferably greater than the thickness of the exterior resin layer SR outside the region between the protrusions. Such a thickness gradient of the exterior resin layer is attributable to the later-described first and second etching steps (particularly the first etching step).

As illustrated in FIG. 4, the thickness of the exterior resin layer SR between the protrusions refers to a thickness al on a reference line P in the stacking direction T. The reference line P passes through the tip of either the protrusion 13a in the upper end portion 11a or the protrusion 13b in the lower end portion 11b that has the greater protrusion length. The thickness al is not limited and may be, for example, greater than or equal to 5 μm and less than or equal to 12 μm (i.e., from 5 μm to 12 μm).

The thickness of the exterior resin layer SR outside the region between the protrusions is the thickness of the exterior resin layer SR in regions of the bottom surface B1 of the body B where no outer electrode is formed and is determined as an average of thicknesses that are measured at 20 specific points of the exterior resin layer SR on the magnetic member M. The thickness of the exterior resin layer SR outside the region between the protrusions is not limited and may be, for example, greater than or equal to 4 μm and less than or equal to 10 μm (i.e., from 4 μm to 10 μm).

In FIG. 3, the outer electrode E includes the protrusions 13a and 13b on both right and left sides in both the upper end portion 11a and the lower end portion 11b. However, the outer electrode E does not need to include protrusions on both the right and left sides. The outer electrode E needs to include a protrusion on one of (preferably both) the right and left sides in at least the lower end portion. In terms of further enhancing the coupling strength between the outer electrode and the extended conductor, the outer electrode preferably includes protrusions on both the right and left sides in each of the upper and lower end portions. The protrusion in the lower end portion of the outer electrode is attributable to execution of the outer electrode formation step after the later-described second etching step.

The outer electrode may be composed of various materials, for example, such as Cu, Ni, and/or Sn, and is preferably Cu. The outer electrode may be formed by any method and may be, for example, a plating electrode formed by direct plating (electroless plating, for example) on the through conductor. The process of forming the outer electrode by plating requires immersion of the body B in a plating solution. However, resin is arranged in voids within the body B (the magnetic member M) as described above, thus reducing infiltration of the plating solution into voids or the like within the magnetic member.

### Modification 1 of First Embodiment of Multilayer Inductor

In the multilayer inductor according to the first embodiment, the outer electrode E includes the protrusions 13a and 13b in the upper end portion 11a and the lower end portion 11b continuously situated across the entire periphery of the outer electrode E in plan view in the stacking direction. However, the outer electrode E does not need to include the protrusions continuously situated across the entire periphery of the outer electrode E and may include protrusions situated discontinuously or intermittently in the entire periphery of the outer electrode E in plan view in the stacking direction. For example, the outer electrode E may include the protrusions in any one cross-sectional view.

### Modification 2 of First Embodiment of Multilayer Inductor

In the multilayer inductor according to the first embodiment, the outer electrodes E are formed like islands (in spots, for example) in plan view in the stacking direction. However, each outer electrode E may be formed continuously in the depth direction of FIG. 3, for example. In other words, the outer electrode E may extend in the W direction of the body like a wall. This outer electrode E may include the protrusions 13a and 13b in the upper end portion 11a and the lower end portion 11b continuously situated in the extension direction or situated discontinuously or intermittently.

### Second Embodiment of Multilayer Inductor

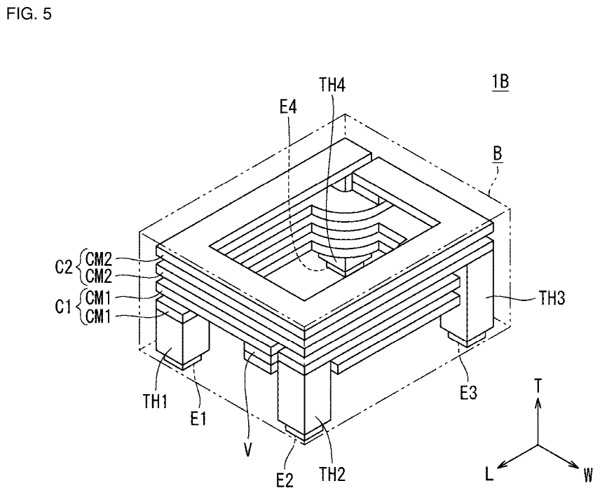

Next, a multilayer inductor 1B of a second embodiment will be described with reference to FIG. 5. The multilayer inductor 1B of the second embodiment is different from the aforementioned multilayer inductor 1A of the first embodiment in configurations concerning coils. Specifically, the multilayer inductor 1B is different from the multilayer inductor 1A in the number of coils, the numbers of coil turns, and the positions of the outer electrodes. The following description will be mainly given of the differences from the multilayer inductor described in the aforementioned embodiment. The structure of each of outer electrodes E1 to E4 of the multilayer inductor 1B of the second embodiment corresponds to the structure of the outer electrodes E1 and E2 of the multilayer inductor 1A of the first embodiment. Therefore, in the second embodiment, similarly to the first embodiment, it is possible to miniaturize the surface area of the outer electrodes E (E1 to E4) as seen from the mounting surface B1 side of the body B. The miniaturization of the surface area of the outer electrodes E allows for effective use of the bottom surface (mounting surface) B1 of the body B in the multilayer inductor 1B of the second embodiment. The structure of each outer electrode includes not only the structure of the outer electrode itself but also the relationship between the outer electrode and the corresponding through conductor, the relationship between the outer electrode and the exterior resin layer, and the relationship between the through conductor and the exterior resin layer.

The multilayer inductor 1B of the second embodiment may include two or more coils that are arranged to overlap in plan view in the stacking direction. In other words, a first coil C1 and a second coil C2 may be provided within the body B. The first coil C1 and the second coil C2 may be magnetically coupled to each other. For example, the coupling coefficient between the first coil C1 and the second coil C2 is greater than or equal to 0.1 and less than or equal to 0.8 (i.e., from 0.1 to 0.8). Within the body B, two coils including only the first coil C1 and the second coil C2 may be provided, or three or more coils including the first coil C1 and the second coil C2 may be provided.

### First Coil

The first coil C1 includes plural first coil conductors CM1 constituting the first coil C1 in the stacking direction (the height direction T, for example). The first coil conductors CM1 adjacent to each other are coupled with a via conductor V interposed therebetween. The first coil C1 may constitute 1.75 coil turns by including in the stacking direction, the first coil conductors CM1 formed in two different layer groups. The number of coil turns is not limited to 1.75 and may be set to, for example, 2 or more by stacking the first coil conductors CM1 in the stacking direction.

### Second Coil

The second coil C2 is arranged above the first coil C1 in the height direction T and includes plural second coil conductors CM2 constituting the second coil in the stacking direction (the height direction T, for example). The second coil conductors CM2 adjacent to each other are coupled with a via conductor V interposed therebetween. The second coil C2 may constitute 1.75 coil turns by including in the stacking direction, the second coil conductors CM2 formed in two different layer groups. The number of coil turns is not limited to 1.75 of the illustrated example and may be set to, for example, 2 or more by stacking the first coil conductors CM1 in the stacking direction. The number of second coil conductors CM2 stacked may be the same as or different from the number of first coil conductors 51 stacked.

### Through conductor and Outer Electrode

The through conductors include a first through conductor TH1, a second through conductor TH2, a third through conductor TH3, and a fourth through conductor TH4. The first through conductor TH1, the second through conductor TH2, the third through conductor TH3, and the fourth through conductor TH4 are provided within the body B. The first through conductor TH1, the second through conductor TH2, the third through conductor TH3, and the fourth through conductor TH4 are exposed in the mounting surface (the first major surface B1) of the body B.

The first through conductor TH1 couples the first outer electrode E1 and the end portion of the first coil Cl that is associated with the first coil conductor CM1 situated closest to the bottom surface of the body B. The first through conductor TH1 may extend in the stacking direction (the height direction T, for example). The first through conductor TH1 may have a multilayer structure.

The second through conductor TH2 couples the other end portion of the first coil C1 and the second outer electrode E2. The second through conductor TH2 may extend in the stacking direction (the height direction T, for example). The second through conductor TH2 may have a multilayer structure.

The third through conductor TH3 couples a third outer electrode E3 and the end portion of the second coil C2 that is associated with the second coil conductor CM2 situated closest to the bottom surface of the body B. The third through conductor TH3 may extend in the stacking direction (the height direction T, for example). The third through conductor TH3 may have a multilayer structure.

The fourth through conductor TH4 couples the other end portion of the second coil C2 and a fourth outer electrode E4. The fourth through conductor TH4 may extend in the stacking direction (the height direction T, for example). The fourth through conductor TH4 may have a multilayer structure.

As illustrated in FIG. 5, the outer electrodes include the first outer electrode E1, the second outer electrode E2, the third outer electrode E3, and the fourth outer electrode E4. The first outer electrode E1 and the second outer electrode E2 are provided in the first major surface B1 of the body B and are electrically connected to the first coil C1. The third outer electrode E3 and the fourth outer electrode E4 are provided in the first major surface B1 of the body B and are electrically connected to the second coil C2. In the multilayer inductor 1B, the first major surface B1 of the body B can serve as the mounting surface.

Even in the multilayer inductor 1B of the second embodiment, resin is provided in at least a part of voids in the magnetic member M and coil conductors. Reducing voids can enhance the body strength.

### Modification of Second Embodiment of Multilayer Inductor

In the multilayer inductor (FIG. 5) according to the second embodiment, all the outer electrodes E are formed like islands (in spots, for example) in plan view in the stacking direction. However, the multilayer inductor 1B may offer an electrode joint structure that uses the island-like outer electrodes as bridge abutments and further includes a bridge girder portion joined thereabove. To be specific, for example, when the outer electrodes E2 and E3 have the same polarity in FIG. 5, the multilayer inductor 1B may offer an electrode joint structure that includes these outer electrodes E2 and E3 as bridge abutments and further includes a bridge girder portion bridging the outer electrodes E2 and E3. In such an electrode joint structure, the outer electrodes as the abutments and the through conductors have sufficient coupling strength, so that the electrode joint structure also has more sufficient coupling strength. The bridge girder portion of the electrode joint structure may be composed of the same material as the outer electrodes E.

### Multilayer Inductor Array

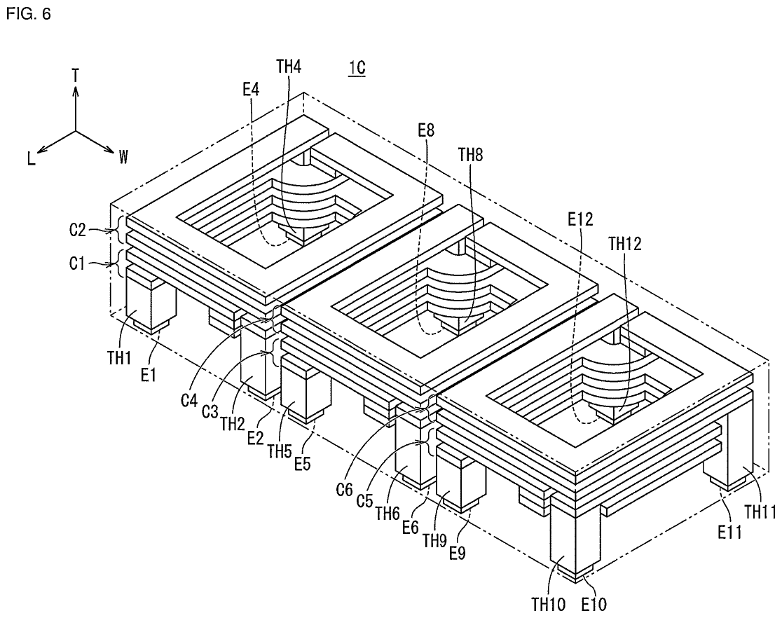

Next, a multilayer inductor array of the present disclosure will be described with reference to FIG. 6. A multilayer inductor array 1C of the present disclosure includes a coil array where sets of two or more coils, which are arranged to overlap in plan view in the stacking direction, are arranged side by side in a direction transverse to the stacking direction (a direction perpendicular to the stacking direction, for example). Specifically, the multilayer inductor array may include, in addition to the first coil C1 and the second coil C2, a third coil C3, a fourth coil C4, a fifth coil C5, and a sixth coil C6. The third coil C3 and the fifth coil C5 have substantially the same structure as the first coil C1, and the fourth coil C4 and the sixth coil C6 have substantially the same structure as the second coil C2.

The third coil C3 may be electrically connected to the fifth outer electrode E5 and the sixth outer electrode E6. The end portion of the third coil C3 that is associated with a third coil conductor layer situated closest to the bottom surface and the fifth outer electrode E5 may be coupled with the fifth through conductor TH5. The other end portion of the third coil conductor layer and the sixth outer electrode E6 may be coupled with the sixth through conductor TH6.

The fourth coil C4 may be electrically connected to a seventh outer electrode (not illustrated) and an eighth outer electrode (not illustrated). The end portion of the fourth coil C4 that is associated with a fourth coil conductor layer situated closest to the bottom surface and the seventh outer electrode may be coupled with a seventh through conductor. The other end portion of the fourth coil conductor layer and the eighth outer electrode may be coupled with an eighth through conductor.

The fifth coil C5 may be electrically connected to a ninth outer electrode E9 and a tenth outer electrode E10. The end portion of the fifth coil C5 that is associated with a fifth coil conductor layer situated closest to the bottom surface and the ninth outer electrode E9 may be coupled with a ninth through conductor TH9. The other end portion of the fifth coil conductor layer and the tenth outer electrode E10 may be coupled with a tenth through conductor TH10.

The sixth coil C6 may be electrically connected to an 11th outer electrode E11 and a 12th outer electrode E12. The end portion of the sixth coil C6 that is associated with a sixth coil conductor layer situated closest to the bottom surface and the 11th outer electrode E11 may be coupled with an 11th through conductor TH11. The other end portion of the sixth coil conductor layer and the 12th outer electrode (not illustrated) may be coupled with a 12th through conductor TH12.

Even in the multilayer inductor array 1C of the present disclosure, the structure of each of the outer electrodes E1 to E12 corresponds to the structure of the outer electrodes E1 and E2 in the multilayer inductor 1A of the first embodiment. Therefore, in the multilayer inductor array 1C of the present disclosure, similar to the first embodiment, it is possible to minimize the surface area of the outer electrodes E (E1 to E12) as seen from the mounting surface B1 side of the body B. The miniaturization of the surface area of the outer electrodes E allows for effective use of the bottom surface (mounting surface) B1 of the body B in the multilayer inductor array 1C of the present disclosure.

### Manufacturing Method of Multilayer Inductor

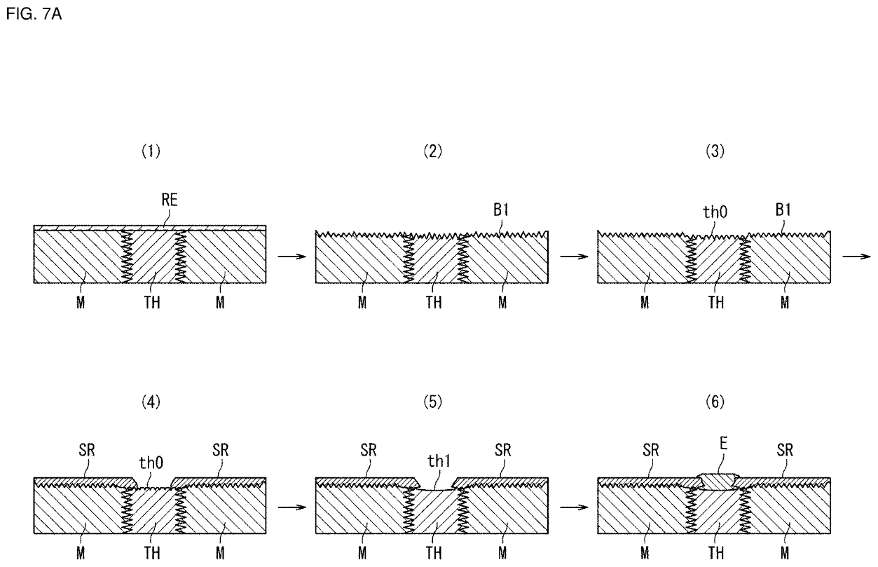

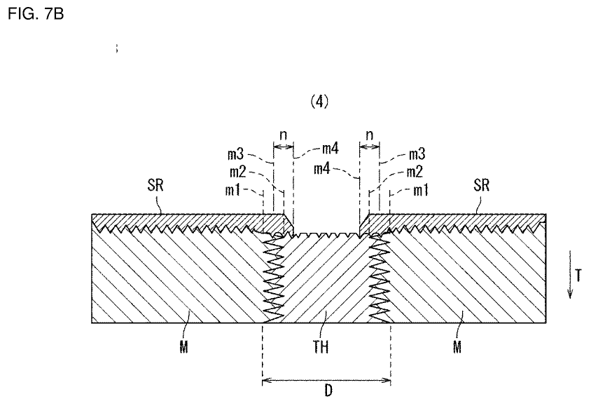

Next, the manufacturing method of a multilayer inductor of the present disclosure will be described using FIG. 7A. FIG. 7A is a flow diagram illustrating the manufacturing method of a multilayer inductor of the present disclosure. The manufacturing method of a multilayer inductor of the present disclosure may include a body precursor preparation step, a resin impregnation preparation step, a resin impregnation step, a grinding step, the first etching step, an exterior resin layer formation step, the second etching step, and the outer electrode formation step. FIG. 7A is cross-sectional diagrams illustrating the resin impregnation step, grinding step, first etching step, exterior resin layer formation step, second etching step, and outer electrode formation step that are more characteristic in the manufacturing method of a multilayer inductor of the present disclosure. Hereinafter, the manufacturing method of a multilayer inductor of the present disclosure will be described in detail along the steps.

### Body Precursor Preparation Step

In this step, a body precursor is prepared, which includes within a magnetic member including a stack of magnetic layers containing iron powder, a coil having coil conductors wound around and through conductors that are electrically connected to the coil conductors and are exposed in the bottom surface of the magnetic member. To be specific, first a magnetic paste constituting the magnetic layers ML of the layer groups described in FIG. 2, a conductor paste constituting the coil conductors CM, and a non-magnetic paste constituting a non-magnetic layer between the coil conductors CM are prepared.

In an example of the preparation method of the magnetic paste, iron powder of a Fe—Si alloy, a Fe—Si—Cr alloy, or the like is prepared. The cumulative 50% particle size D50 by volume, of this iron powder is greater than or equal to 2 μm and less than or equal to 20 μm (i.e., from 2 μm to 20 μm). This iron powder is mixed with cellulose, polyvinyl butyral (PVB), or the like as a binder and a mixture of terpineol and butyl diglycol acetate (BCA) or the like as a solvent. The mixture is then kneaded to prepare the magnetic paste.

When the iron powder is a Fe—Si alloy, preferably, the content of Si is greater than or equal to 2.0 at % and less than or equal to 8.0 at % (i.e., from 2.0 at % to 8.0 at %). When the iron powder is a Fe—Si—Cr alloy, preferably, the content of Si is greater than or equal to 2.0 at % and less than or equal to 8.0 at % (i.e., from 2.0 at % to 8.0 at %). When the iron powder is a Fe—Si—Cr alloy, preferably, the content of Cr is greater than or equal to 0.2 at % and less than or equal to 6.0 at % (i.e., from 0.2 at % to 6.0 at %).

The iron powder may be provided with an insulating coating. The insulating coating is preferably a coating containing a metal oxide and more preferably a coating containing an oxide of Si. The method of forming the insulating coating is preferably a sol-gel process. In an example of the method of forming the insulating coating by a sol-gel process, a sol-gel coating agent containing Si alkoxide and an organic chain-containing silane coupling agent are mixed to create a mixture. The mixture is attached to the surface of the metal magnetic powder. The resultant is then subjected to heat treatment for dehydration synthesis and is then dried at a predetermined temperature to form the insulating coating.

In an example of the preparation method of the non-magnetic paste, Fe₂O₃, ZnO, and CuO and if necessary, additives are weighed to achieve a predetermined composition. The weighed substances together with pure water, a dispersant, and a PSZ medium are put into a ball mill and are mixed and pulverized to prepare a slurry. The prepared slurry is dried and then calcinated at a temperature of higher than or equal to 700° C. and lower than or equal to 800° C. (i.e., from 700° C. to 800° C.) for greater than or equal to two hours and less than or equal to three hours (i.e., from two hours to three hours), thus preparing a non-magnetic material (calcinated powder). The non-magnetic material (calcinated powder) is mixed with predetermined amounts of solvent (ketone-based solvent or the like), resin (polyvinyl acetal or the like), and a plasticizer (an alkyd-based plasticizer). The mixture is kneaded with a planetary mixer and is then dispersed with a three-roll mill to prepare the non-magnetic paste.

As the main components, the non-magnetic paste preferably contains Fe equivalent to Fe₂O₃ in an amount of greater than or equal to 40 mol % or less than or equal to 49.5 mol % (i.e., from 40 mol % to 49.5 mol %), Cu equivalent to CuO in an amount of greater than or equal to 4 mol % and less than or equal to 12 mol % (i.e., from 4 mol % to 12 mol %), and ZnO as the remainder. More preferably, the non-magnetic paste contains Mn, Bi, Co, Si, Sn, or the like as an additive if necessary, in addition to the aforementioned main components. The non-magnetic paste may contain inevitable impurities.

As the conductor paste, for example, a paste containing Ag as a conductive material is prepared.

The aforementioned magnetic paste, non-magnetic paste, and conductor paste are used to prepare the layer groups G1 to G7 illustrated in FIG. 2 using screen printing or the like. The unfired body precursor is subjected to pressure treatment by a press process, such as warm isostatic press (WIP), into a multilayer body. After the pressure treatment, the multilayer body is put into a firing furnace for degreasing and is then fired in an air atmosphere. The firing temperature is, for example, higher than or equal to 600° C. and lower than or equal to 800° C. (i.e., from 600° C. to 800° C.). The firing time is, for example, greater than or equal to 30 minutes and less than or equal to 90 minutes (i.e., from 30 minutes to 90 minutes). By the firing, the body is prepared.

### Resin Impregnation Preparation Step (Optional Step)

The resin impregnation preparation step is optionally performed before the resin impregnation step described later. Specifically, the resin impregnation preparation step is a step to reduce gas or moisture in the body or to reduce the viscosity of the resin.

An example method of the resin impregnation preparation step further facilitates resin impregnation by degassing the fired body to reduce gas within the body. The degassing and resin impregnation may be repeatedly performed. Another method of the resin impregnation preparation step may be a method that further facilitates resin impregnation by warming the fired body to reduce the moisture within the body. Still another method of the resin impregnation preparation step may be a method that facilitates resin impregnation by warming resin to reduce the viscosity of the resin. The resin impregnation preparation step allows for effective resin impregnation of the body.

### Resin Impregnation Step (Optional Step)

In this step, the fired body precursor is impregnated with resin. The resin impregnation step may be an optional step. In the case of performing this step, resin may contain, for example, epoxy resin, silicone resin, or phenol resin. By impregnating the body with resin, the resin is provided in at least a part of voids in the magnetic member and coil conductors. This can reduce voids and enhance the body strength. Moreover, it is possible to reduce infiltration of the plating solution or moisture into the body. As a result of the resin impregnation step, impregnation resin residue RE remains on the magnetic member bottom surface B1 (the first major surface B1) side in the body precursor (FIG. 7A(1)).

### Grinding Step

In this step, in the body precursor impregnated with resin, the impregnation resin residue RE on the magnetic member bottom surface B1 side is ground and removed to expose at least the end surface of the through conductor TH and thereby prepare the body (FIG. 7A(2)). By the grinding, the aforementioned surface roughness can be given to the magnetic member bottom surface B1, and the thickness of the body can be adjusted to a predetermined thickness. The grinding step may be performed for the body precursor not yet impregnated with resin.

### First Etching Step (Optional Step)

This step is optionally performed before the later-described exterior resin layer formation step. Specifically, in the magnetic member bottom surface of the body resulting from the grinding step, at least the through conductor end surface is etched to prepare a new through conductor end surface th0 (FIG. 7A(3)). As described above, the first etching step creates, on the magnetic member bottom surface B1 side, a thickness gradient in which the thickness of the exterior resin layer SR between the protrusions is greater than the thickness of the exterior resin layer SR outside the region between the protrusions. This further enhances the coupling strength between the outer electrode and the through conductor. The etching solution is a liquid that is able to dissolve the through conductor and the magnetic member M. Examples of such an etching solution may include potassium nitrate-ammonia water, sodium cyanide, and phosphoric acid-hydrogen peroxide-water. In the first etching step, the magnetic member is barely etched if the magnetic member M is impregnated with resin.

### Exterior Resin Layer Formation Step

In this step, the exterior resin layer SR is formed in the region other than the through conductor end surface in the magnetic member bottom surface of the body (FIG. 7A(4)). The exterior resin layer SR is a protective layer against the later-described second etching step and may be, for example, a solder resist layer. The method of forming the exterior resin layer SR is not limited as long as the exterior resin layer SR can be selectively formed in the region other than the through conductor end surface and may be, for example, a screen-printing process. The screen-printing process may use the aforementioned resin solution constituting the exterior resin layer SR as ink.

In the exterior resin layer formation step, the exterior resin layer SR is formed in the magnetic member bottom surface of the body so as to be opened in the region substantially corresponding to the through conductor end surface. To be specific, the opening area of the exterior resin layer SR is smaller than the area of the end surface of the through conductor TH. When the opening area of the exterior resin layer SR is smaller than the area of the end surface of the through conductor TH, an overlap is provided between the exterior resin layer SR and the through conductor TH (particularly the end surface) in plan view. Gap is thereby created between the through conductor end surface and the exterior resin layer in the later-described second etching step, and the protrusion 13b in the lower end portion of the outer electrode is formed in the later-described outer electrode formation step.

FIG. 7B is a cross-sectional view illustrating the details of the exterior resin layer formation step in the manufacturing method of a multilayer inductor of the present disclosure. The opening of the exterior resin layer refers to an opening in plan view in the stacking direction T as if the outer electrode were transparent and is indicated by a region between two reference lines m4 in FIG. 7B. The reference lines m4 refer to reference lines that are parallel to the stacking direction T and define the opening of the exterior resin layer SR.

The end surface of the through conductor TH is indicated by, for example, a region between two reference lines m3 in FIG. 7B. The reference lines m3 refer to median lines between reference lines m1 and respective reference lines m2 in cross-sectional view. The reference lines m1 extend in parallel to the stacking direction T and define the maximum diameter of the through conductor TH. The reference lines m2 extend in parallel to the stacking direction T and define the minimum diameter of the through conductor TH. Diameter D of the through conductor TH refers to the maximum diameter defined by the reference lines m1 and can be measured from an X-ray fluoroscopic image of the multilayer inductor from the bottom side or in a direction substantially perpendicular to the stacking direction T.

In the exterior resin layer formation step, to be specific, in plan view in the stacking direction, of the body with the exterior resin layer SR formed, the exterior resin layer SR is formed so as to overlap the outer peripheral edge of the end surface of the through conductor TH. A dimension n of the overlap in the outer peripheral edge of the end surface of the through conductor TH needs to be such a dimension that gap corresponding to the protrusion 13b can be formed between the end surface of the through conductor and the exterior resin layer in the later-described second etching step. The dimension n of the overlap in the outer peripheral edge of the end surface of the through conductor TH is expressed by the distance between the corresponding reference lines m3 and m4 and may be, for example, greater than or equal to 2 μm and particularly greater than or equal to 50 μm (i.e., from 2 μm to 50 μm). It is preferable that the dimension n is larger within a range where the opening of the exterior resin layer SR is formed. The upper limit of the dimension n is therefore not restricted. The dimension n may be, for example, less than or equal to 70 μm and particularly less than or equal to 20 μm (i.e., from 70 μm to 20 μm).

### Second Etching Step

In this step, the through conductor end surface is etched in the magnetic member bottom surface of the body with the exterior resin layer formed thereon to create a new through conductor end surface th1 (FIG. 7A (5)). By performing the later-described outer electrode formation step after the second etching step, the protrusion 13b in the lower end portion of the outer electrode is formed. To be specific, when the through conductor end surface is etched in the second etching step, the through conductor end surface lowers to form the through conductor end surface th1. This creates gap corresponding to the protrusion portion 13b between the through conductor end surface and the exterior resin layer. The protrusion 13b in the lower end portion of the outer electrode is therefore formed by the later-described outer electrode formation step.

In the second etching step, the etching solution is a liquid that is able to dissolve the through conductor but is not able to dissolve the exterior resin layer SR. Such an etching solution may be a solution containing potassium cyanide, phosphoric acid, nitric acid, acetic acid, and thiourea, for example. The etching time may be, for example, greater than or equal to 30 seconds and less than or equal to 900 seconds (i.e., from 30 seconds to 900 seconds) and preferably greater than or equal to 500 seconds and less than or equal to 700 seconds (i.e., from 500 seconds to 700 seconds) (particularly 600 seconds).

### Outer Electrode Formation Step

The outer electrode formation step is a step of forming the outer electrode E electrically connected to the coil conductor (FIG. 7A(6)). The outer electrode is formed in the opening (the position where the through conductor is exposed in the mounting surface (the first major surface B1) of the body B) of the exterior resin layer SR by electroless plating. The plating material may be Cu. The other examples of the plating material include, but not limited to, Ni—Sn, Ni—Au, Ni—Cu, and/or Cu—Ni—Au.

The gap corresponding to the protrusion 13b is created between the through conductor end surface and the exterior resin layer in the second etching step. Therefore, the protrusion 13b is formed in the lower end portion just by forming the outer electrode in the outer electrode formation step.

In the outer electrode formation step, it is important to form the outer electrode such that the outer electrode protrudes from the surface of the exterior resin layer SR. The protrusion 13a is thereby formed in the upper end portion of the outer electrode.

When a series of plural multilayer inductors are obtained by the exterior resin layer formation step, the product is singulated by cutting (a dicing step) after the outer electrode formation, thus manufacturing the multilayer inductors of the embodiments.

The aforementioned body precursor preparation step, resin impregnation preparation step, resin impregnation step, grinding step, first etching step, exterior resin layer formation step, second etching step, and outer electrode formation step typically are performed sequentially in this order. The resin impregnation preparation step and the first etching step may be independently omitted or executed. For example, in the case of omitting the first etching step, to be specific, the body resulting from the grinding step is sequentially subjected to the exterior resin layer formation step, second etching step, and outer electrode formation step.

The technical scope of the present disclosure is not understood by only the aforementioned embodiments and is defined based on the description in Claims. The technical scope of the present disclosure includes the meaning equivalent to Claims and all changes within Claims.

The multilayer inductor of the present disclosure and the manufacturing method thereof include the following aspects.
<1> A multilayer inductor including a body. The body includes, within a magnetic member having a stack of magnetic layers containing iron powder, a coil including a coil conductor wound around; and a through conductor that is electrically connected to the coil conductor and is extended toward a bottom surface of the magnetic member. The multilayer inductor includes an outer electrode that is arranged on the through conductor and is electrically connected to the through conductor; and an exterior resin layer arranged on the bottom surface of the magnetic member of the body. The outer electrode includes protrusions that protrude perpendicular to a stacking direction of the magnetic layers in an upper end portion on a far side from the through conductor and a lower end portion on a near side from the through conductor in the stacking direction. The exterior resin layer is arranged across between the protrusions in the upper end portion and the lower end portion.
<2> The multilayer inductor according to <1>, in which widths of the upper end portion and the lower end portion of the outer electrode are greater than an opening width of the exterior resin layer in the cross-sectional view.
<3> The multilayer inductor according to <1> or <2>, in which widths of the upper end portion and the lower end portion of the outer electrode are smaller than a diameter of the through conductor in the cross-sectional view.
<4> The multilayer inductor according to any one of <1> to <3>, in which a thickness of the exterior resin layer on the through conductor is greater than a thickness of the exterior resin layer other than on the through conductor.
<5> The multilayer inductor according to any one of <1> to <4>, in which the outer electrode is a plating electrode directly formed on the through conductor.
<6> The multilayer inductor according to any one of <1> to <5>, in which the outer electrode is a copper plating electrode, and the through conductor is a silver-sintered body.
<7> The multilayer inductor according to any one of <1> to <6>, in which a surface roughness of the bottom surface of the magnetic member of the body is greater than a surface roughness of a surface of the magnetic member of the body that is opposite to the bottom surface.
<8> The multilayer inductor according to any one of <1> to <7>, in which a surface roughness of the bottom surface of the magnetic member of the body is greater than a surface roughness of an end surface of the through conductor.
<9> The multilayer inductor according to any one of <1> to <8>, in which the body further includes resin arranged in voids within the magnetic member.
<10> The multilayer inductor according to any one of <1> to <9>, in which the coil comprises two or more coils that are arranged to overlap in plan view in the stacking direction.
<11> The multilayer inductor according to any one of <1> to <10>, in which the coil comprises coils constituting a coil array where sets of two or more coils, which are arranged to overlap in plan view in the stacking direction, are arranged side by side in a direction transverse to the stacking direction.
<12> A method of manufacturing a multilayer inductor, including a body precursor preparation step of preparing a body precursor that includes within a magnetic member having a stack of magnetic layers containing iron powder, a coil including a coil conductor wound around, and a through conductor that is electrically connected to the coil conductor and is exposed in a bottom surface of the magnetic member; and a grinding step of grinding and removing residues of impregnated resin on a bottom surface side of the magnetic member in the body precursor to expose an end surface of the through conductor and prepare a body. The method also includes an exterior resin layer formation step of forming an exterior resin layer on the bottom surface of the magnetic member of the body such that the exterior resin layer overlaps an outer peripheral edge of the end surface of the through conductor in plan view in a stacking direction; an etching step of etching the end surface of the through conductor in the exterior resin layer formation surface of the body; and an outer electrode formation step of forming on the end surface of the through conductor, an outer electrode electrically connected to the coil conductor.
<13> The method of manufacturing a multilayer inductor according to <12>, further including a resin impregnation step of impregnating the body precursor with resin between the body precursor preparation step and the grinding step.
<14> The method of manufacturing a multilayer inductor according to <12> or <13>, further including an etching step of etching the end surface of the through conductor in the bottom surface of the magnetic member of the body, between the grinding step and the exterior resin layer formation step.
<15> The method of manufacturing a multilayer inductor according to any one of <12> to <14>, in which the multilayer inductor according to any one of <1> to <11> is manufactured.

The present disclosure is applicable to a multilayer inductor with enhanced coupling strength between an outer electrode and a through conductor.

What is claimed is:

1. A multilayer inductor comprising:
a body including:
a magnetic member including magnetic layers including iron powder stacked:
a coil including a coil conductor wound around; and
a through conductor which is electrically connected to the coil conductor and is extended toward a bottom surface of the magnetic member;
an outer electrode which is on the through conductor and is electrically connected to the through conductor; and
an exterior resin layer on the bottom surface of the magnetic member of the body, wherein
the outer electrode includes protrusions that protrude perpendicular to a stacking direction of the magnetic layers in an upper end portion on a far side from the through conductor and a lower end portion on a near side from the through conductor in the stacking direction, and
the outer electrode is between the protrusions in the upper end portion and the lower end portion.

2. The multilayer inductor according to claim 1, wherein
widths of the upper end portion and the lower end portion of the outer electrode are greater than a width of an opening of the exterior resin layer in a cross-sectional view.

3. The multilayer inductor according to claim 1, wherein
widths of the upper end portion and the lower end portion of the outer electrode are smaller than a diameter of the through conductor in a cross-sectional view.

4. The multilayer inductor according to claim 1, wherein
a thickness of the exterior resin layer on the through conductor is greater than a thickness of the exterior resin layer other than on the through conductor.

5. The multilayer inductor according to claim 1, wherein
the outer electrode is a plating electrode directly on the through conductor.

6. The multilayer inductor according to claim 1, wherein
the outer electrode is a copper plating electrode, and
the through conductor is a silver-sintered body.

7. The multilayer inductor according to claim 1, wherein
a surface roughness of the bottom surface of the magnetic member of the body is greater than a surface roughness of a surface of the magnetic member of the body that is opposite to the bottom surface.

8. The multilayer inductor according to claim 1, wherein
a surface roughness of the bottom surface of the magnetic member of the body is greater than a surface roughness of an end surface of the through conductor.

9. The multilayer inductor according to claim 1, wherein
the body further includes resin in voids within the magnetic member.

10. The multilayer inductor according to claim 1, wherein
the coil comprises two or more coils that overlap in plan view in the stacking direction.

11. The multilayer inductor according to claim 1, wherein
the coil comprises coils configuring a coil array where sets of two or more coils, which overlap in plan view in the stacking direction, are side by side in a direction transverse to the stacking direction.

12. A method of manufacturing a multilayer inductor, comprising:
preparing a body precursor that includes a magnetic member including magnetic layers including iron powder stacked, a coil including a coil conductor wound around, and a through conductor which is electrically connected to the coil conductor and is exposed in a bottom surface of the magnetic member;
grinding and removing residues of impregnated resin on a bottom surface side of the magnetic member in the body precursor to expose an end surface of the through conductor and prepare a body;
forming an exterior resin layer on the bottom surface of the magnetic member of the body such that the exterior resin layer overlaps an outer peripheral edge of the end surface of the through conductor in plan view in a stacking direction;
etching the end surface of the through conductor in the exterior resin layer formation surface of the body; and
forming an outer electrode electrically connected to the coil conductor on the end surface of the through conductor.

13. The method of manufacturing a multilayer inductor according to claim 12, further comprising:
impregnating the body precursor with resin between the preparing of the body precursor and the grinding.

14. The method of manufacturing a multilayer inductor according to claim 12, further comprising:
etching the end surface of the through conductor in the bottom surface of the magnetic member of the body, between the grinding and the forming of the exterior resin layer.

15. The method of manufacturing a multilayer inductor according to claim 12, which manufactures a multilayer inductor comprising:
a body including:
a magnetic member including magnetic layers including iron powder stacked:
a coil including a coil conductor wound around; and
a through conductor which is electrically connected to the coil conductor and is extended toward a bottom surface of the magnetic member;
an outer electrode which is on the through conductor and is electrically connected to the through conductor; and
an exterior resin layer on the bottom surface of the magnetic member of the body, wherein
the outer electrode includes protrusions that protrude perpendicular to a stacking direction of the magnetic layers in an upper end portion on a far side from the through conductor and a lower end portion on a near side from the through conductor in the stacking direction, and
the outer electrode is between the protrusions in the upper end portion and the lower end portion.

16. The method of manufacturing a multilayer inductor according to claim 15, wherein
widths of the upper end portion and the lower end portion of the outer electrode are greater than a width of an opening of the exterior resin layer in a cross-sectional view.

17. The method of manufacturing a multilayer inductor according to claim 15, wherein
widths of the upper end portion and the lower end portion of the outer electrode are smaller than a diameter of the through conductor in a cross-sectional view.

18. The method of manufacturing a multilayer inductor according to claim 15, wherein
a thickness of the exterior resin layer on the through conductor is greater than a thickness of the exterior resin layer other than on the through conductor.

19. The method of manufacturing a multilayer inductor according to claim 15, wherein
the outer electrode is a plating electrode directly on the through conductor.

20. The method of manufacturing a multilayer inductor according to claim 15, wherein
the outer electrode is a copper plating electrode, and
the through conductor is a silver-sintered body.
